(19) United States
(12) Patent Application Publication
(10) Pub. No.: US 2026/0119129 A1
(43) Pub. Date: Apr. 30, 2026

(54) DATA OBJECT DEFINITION AND REGISTRATION FOR APPLICATION DEVELOPMENT AND EXECUTION PLATFORMS

(71) Applicant: Tracelink, Inc., Wilmington, MA (US)

(72) Inventors: Robert Sturim, Wenham, MA (US); Robert Ian Anthony Morgan, Middleton, MA (US); Donald Stephen McAfee, Lunenburg, MA (US)

(73) Assignee: Tracelink, Inc., Wilmington, MA (US)

(21) Appl. No.: 18/926,297

(22) Filed: Oct. 24, 2024

(51) Int. Cl. G06F 8/34; G06F 8/38

(52) U.S. Cl. CPC G06F 8/34; G06F 8/38

(57) ABSTRACT

A data object definition and registration method includes invoking a user interface and placing a screen in the data object creation user interface. The method further includes selecting a data object in the user interface for association with different functions exposed by an application programming interface (API) of an application, the data object including one or more data elements and associated ones of the different functions. The method yet further includes associating in the user interface the data object with an external data object function defined separately from the selected data object as an event processible by an event handler, the association including reference to the one or more data elements and adding a control to the screen for the external data object function. Finally, the method includes registering the external data object function with an event handler.

### BACKGROUND OF THE INVENTION

### Field of the Invention

The present invention relates to the technical field of enterprise computing and more particularly to the development of a specialized instance of an enterprise application in a multi-user application development and execution platform.

### Description of the Related Art

Traditional computing includes the execution of a computer program in memory of a computer by a processor of the computer. However, modern trends in computing capitalize on the notion of a multi-tenant computing environment. A multi-tenant computing environment is a hosted computing environment in which a single instance of a computer program executes in a centralized computing infrastructure while remaining accessible to multiple different users across multiple different organizations. In particular, in comparison to a multi-instance architecture, in a multi-tenant environment, each tenant is a group of users sharing common access with specific privileges to a single instance of the computer program. Each tenant then enjoys a dedicated share of the single instance of the computer program, including corresponding data, configuration, user management, tenant individual functionality and non-functional properties.

It is a distinct advantage of the multi-tenancy architecture that all subscribers, also known as “tenants”, receive access to a most recent version of a commonly accessed application since updating the application for one tenant necessarily means updating the application for all tenants. However, it is a less obvious, but an equally important disadvantage of a multi-tenant environment that all subscribers are compelled to use an identical version of an application since all subscribers access the same instance of the same application at any given time. Thus, the need for a particular tenant to deploy a customized instance of an application conflicts with the characteristic of the multi-tenant environment that all tenants interact with the identical instance of the application.

To address the need for some customization of an application instance for each different tenant in a multi-tenant environment, the modern application development and execution platform provides development functionality permitting an individual tenant to deploy customized program logic and customized user interface screens in connection with a pre-defined generic application. The generic application provides for basic data operations including create, read, update and delete data operations on a data store, and basic user interface screens through which these data operations may be invoked. To provide more in a customized deployment of the basic application requires the intervention of a skilled software developer. So much, though, runs counter to the low-code/no-code trend of self-service, solution-space driven software development in which the end user, irrespective of technical wherewithal, elect to adapt a generic application to the specific needs of the end user within a multi-tenant computing environment.

### BRIEF SUMMARY OF THE INVENTION

Embodiments of the present invention address technical deficiencies of the art in respect to deploying a customized instance of an application instance in a multi-tenant environment. To that end, embodiments of the present invention provide for a novel and non-obvious method for a data object definition and registration in an application development and execution platform of a multi-tenant environment. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a data object definition and registration method includes invoking a data object creation user interface in an object manager of an application development and execution platform. The method further includes placing a screen in the data object creation user interface. The method yet further includes selecting a data object in the user interface for association with different functions exposed by an application programming interface (API) of an application defined within the application development and execution platform, the data object including one or more data elements and associated ones of the different functions. The method yet further includes associating in the user interface the data object with an external data object function defined separately from the selected data object as an event processible by an event handler, the association including reference to the one or more data elements. The method even yet further includes adding a control to the screen for the external data object function. Finally, the method includes registering the external data object function with an event handler for the application development and execution platform.

In one aspect of the embodiment, the method additionally includes deploying the selected data object as a selectable element in a user interface definition canvas of a solutions development module coupled to the application development and execution platform. Then, a corresponding user interface control may be selected which is adapted to access the external data object function. The selected corresponding user interface control is then positioned by the logic of the application development and execution platform in a user interface screen of a solution reflective of a customized form of the application. Finally, the user interface screen can be persisted for use with the solution as a customized form of the application.

In another aspect of the embodiment, the method additionally includes displaying a user interface control in which a customizable parameter may be selected which characterizes the data object. As such, meta data can then be written to the data object encapsulating the customizable parameter. To that end, in yet another aspect of the embodiment, the customizable parameter is a specific database manager managing create, update and delete operations on the data object, and the different functions exposed by the API of the application additionally include a supplemental function externally registered with the application development and execution platform in addition to those of the functions which are included as part of the API.

In another embodiment of the invention, a data processing system is adapted for data object definition and registration. The system includes a host computing platform of one or more computers, each with memory and one or processing units including one or more processing cores. The system also includes an application development and execution platform executing by the one or more processing cores of the host computing platform. The system further includes an event handler for the application development and execution platform and an API of an application defined within the application development and execution platform. Finally, the system includes a data object definition and registration module.

The module includes computer program instructions enabled while executing in the memory of at least one of the processing units of the host computing platform to invoke a data object creation user interface in an object manager of an application development and execution platform in which a screen is defined for a data object of the application along with data elements encapsulated by the data object and corresponding data element manipulation functions. The program instructions additionally select a data object in the user interface for association with different functions exposed by the API of the application defined within the application development and execution platform, the data object including one or more data elements. The program instructions yet further associated in the user interface the data object with an external data object function defined separately from the selected data object as an event processible by an event handler, the association including reference to the one or more data elements. Finally, the program instructions register the external data object function with the event handler.

In this way, the technical deficiencies of deploying a customized instance of an application in a multi-tenant environment are overcome owing to the constraint of selecting a data object in the user interface for association with only those different functions already exposed by the API of the application defined within the application development and execution platform and the subsequent association in the user interface of the data object with an external data object function defined separately from the selected data object as an event processible by an event handler. In this way, the customization of the application with the selected data object in the user interface can be achieve without the need for the end user to engage in complex programming linking the data elements of the data object with the existing functions of the application exposed by the API.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of data object definition and registration;

FIG. 2 is a block diagram depicting a data processing system adapted to perform one of the aspects of the process of FIG. 1; and,

FIG. 3 is a flow chart illustrating one of the aspects of the process illustrated in FIG. 1.

### DETAILED DESCRIPTION OF THE INVENTION

Embodiments of the invention provide for data object definition and registration. In accordance with an embodiment of the invention, an application development and execution platform displays a user interface which when deployed as part of an application, permits different instances of data objects to be manipulated and subjected to programmatic functions including data operations such as create, read, update and delete. A palette of selectable data objects previously associated with the application can be presented by the application development and execution platform in connection with the user interface. Further, a screen is selected and rendered in the application development and execution platform. Thereafter, responsive to the selection of a corresponding one of the data objects including one or more data elements encapsulated therein, one or more data elements of the selected data object are additionally selected for inclusion in the screen along with corresponding user interface controls invoking selected pre-existing operations upon the included data elements.

Of note, an external data object function defined separately from the pre-existing operations of the selected data object is associated with one or more of the data elements of the selected data object as an event processible by an event handler. As a consequence, the external data object function is registered with an event handler of the platform so that when the external data object function is invoked in the user interface subsequent to deployment, the selected data object can be placed on an event bus of the platform to be handled by the event handler registered for the external data object function.

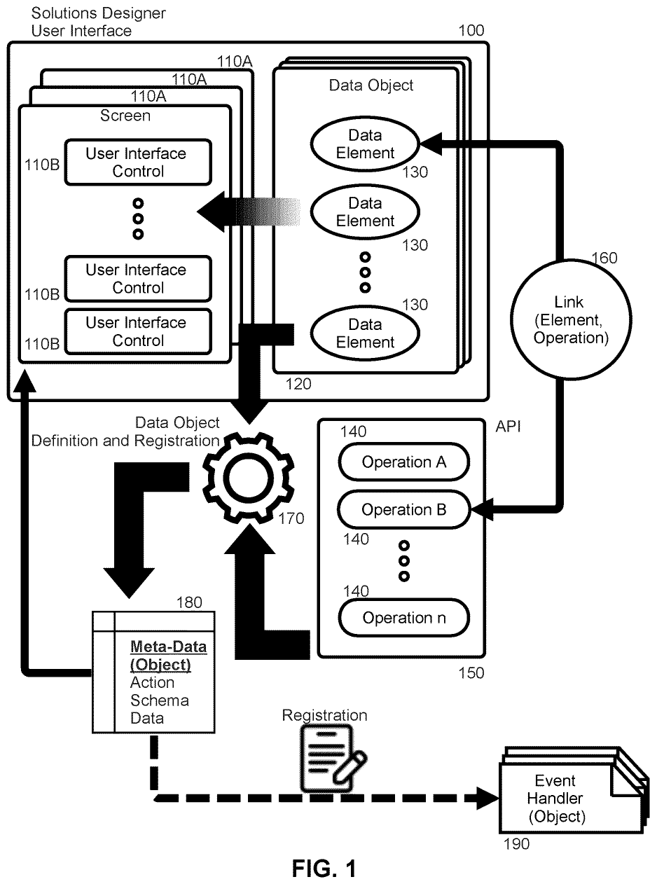

In illustration of one aspect of the embodiment, FIG. 1 pictorially shows a process of data object definition and registration. As shown in FIG. 1, a solutions designer user interface 100 to an application development and execution platform is provided in which a user interface to an application instance is defined according to a selected screen 110A. A particular one of a set of data objects 120 is selected, each of the data objects 120 encapsulating one or more data elements 130. As such, different ones of the data elements 130 are selected for placement into the selected screen 110A in response to which corresponding, pre-determined user interface controls 110B are placed within the selected screen 110A. To that end, each of the placed ones of the user interface controls 110B refers to a corresponding one of the data elements 130 encapsulated within the particular one of the set of the data objects 120 and which further has associated therewith, a link 160. The link 160 associates the corresponding one of the data elements 130 with an operation 140 of an application programming interface (API) to the application instance. In this regard, the operation 140 can include a data operation such as create, read, update or delete.

Within the solutions designer user interface 100, a palette of the set of the data objects 120 is rendered so that, in response to the selection of a corresponding one of the data elements 130 encapsulated within the particular one of the set of the data objects 120, the link 160 is defined associating one or more of the data elements 130 of the selected one of the data objects 120 with a corresponding one of the operations 140 of the API 150. The link 160 is then memorialized by data object definition and registration logic 170 within meta-data 180 so that the registration logic 170 registers the corresponding one of the operations 140 as an event processible by an event handler 190. In this way, when the corresponding one of the operations 140 is invoked in the user interface subsequent to the deployment of the application instance, the meta-data object 180 can be placed onto an event bus of the platform to be handled by the event handler 190 registered for the corresponding one of the operations 140.

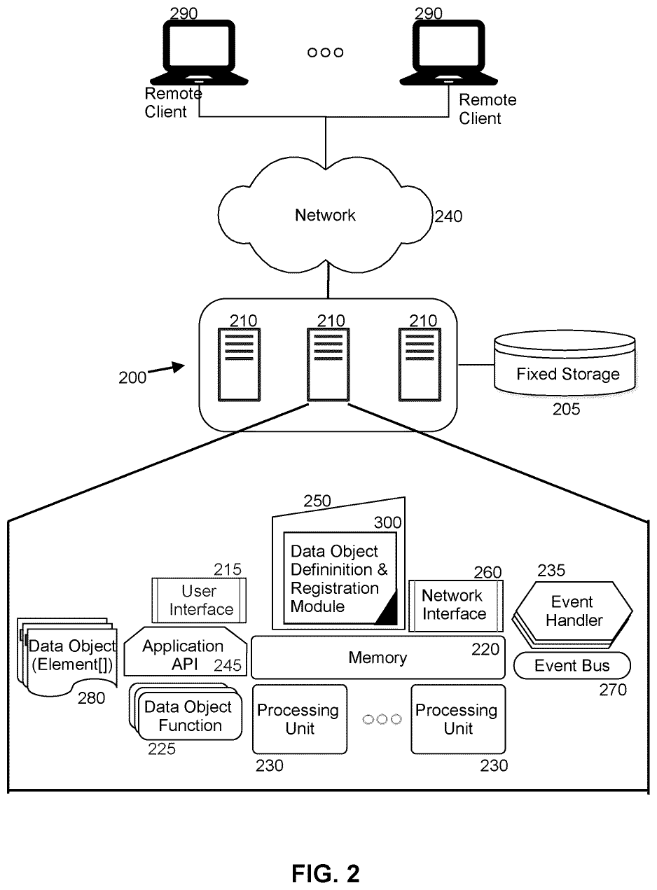

Aspects of the process described in connection with FIG. 1 can be implemented within a data processing system. In further illustration, FIG. 2 schematically shows a data processing system adapted to perform data object definition and registration. In the data processing system illustrated in FIG. 1, a host computing platform 200 is provided. The host computing platform 200 includes one or more computers 210 (detail of only a single computer shown for the purpose of illustrative simplicity), each with memory 220 and one or more processing units 230 and fixed storage 205. A network interface 260 further is provided such that remote clients 290 access the computers 210 of the host computing platform 200 by way of a data communications network 240 through the network interface 260. As it will be understood, the computers 210 of the host computing platform 200 can be co-located within one another and in communication with one another over a local area network, or over a data communications bus.

At least one of the computers 210 includes a computing device 250. The device 250 includes a non-transitory computer readable storage medium accessible by the processing units 230 of one or more of the computers 210. The computing device stores 250 thereon or retains therein a program module 300 that includes computer program instructions which when executed by one or more of the processing units 230, performs a programmatically executable process for data object definition and registration for an application development and execution platform. Specifically, the program instructions during execution direct the rendering of a solutions designer user interface 215 for an application in which a palette of selectable data objects 280 of the application is disposed. The program instructions additionally respond to a selection of a screen amongst a set of selectable screens by rendering the selected screen within the solution designer user interface 215.

The program instructions respond to a selection of one of the data objects 280 by defining a meta-data artifact associating one or more of the data elements of the selected one of the data objects 280 with a corresponding one of a selection of data object functions 225 of an API 245 of an application. The program logic then registers the meta-data object as an event processible by a specific one of a set of event handlers 235. In this way, when the corresponding one of the data object functions 225 is invoked in a rendering of the screen placed within the solutions designer user interface 215, subsequent to the deployment of an associated instance of the application, the meta-data artifact can be placed onto event bus 270 to be handled by the registered one of the event handlers 235 registered for the corresponding one of the data object functions 225.

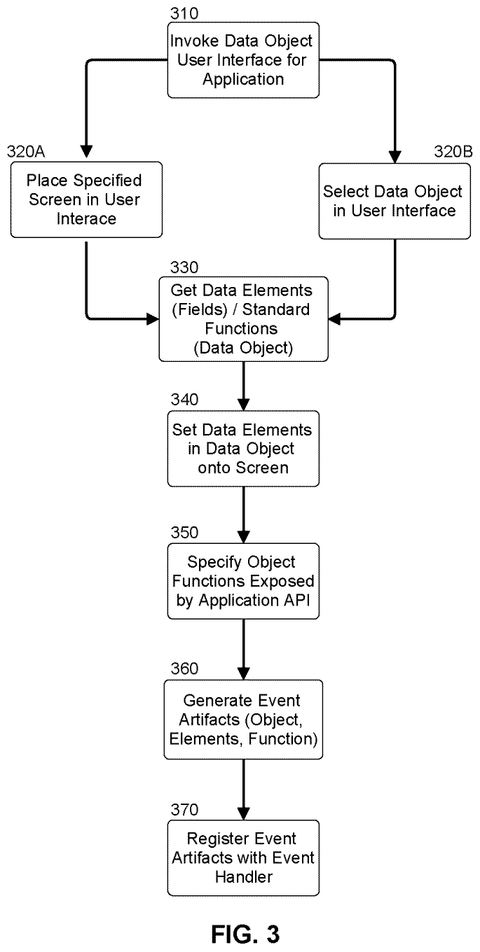

In further illustration of an exemplary operation of the module, FIG. 3 is a flow chart illustrating one of the aspects of the process of FIG. 1. Beginning in block 310, within the solutions designer user interface adapted to specify one or more screens of an application instance of an application, a palette of data objects is displayed for selection within the solutions designer user interface. In block 320A, a screen is specified for configuration within the solutions designer user interface. Concurrently, in block 320B, one of the data objects in the palette is selected. Subsequently, in block 330, the data elements of the selected data object re retrieved along with references to functions manipulating the data elements.

Thereafter, in block 340, one or more data elements encapsulated by the one of the data objects are selected for inclusion in the specified screen. Then, in block 345, an object function exposed by an API to the application is associated with the elements of the one of the data objects. Based upon the association, in block 360, a meta-data artifact is generated linking the data elements to the object function. Finally, in block 370 the meta-data artifact is registered as an event for the application instance in connection with an event handler adapted to process the placement of the event on an event bus supporting the execution of the application instance.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A data object definition and registration method comprising:
invoking a data object creation user interface in an object manager of an application development and execution platform;
placing a screen in the data object creation user interface;
selecting a data object in the user interface for association with different functions exposed by an application programming interface (API) of an application defined within the application development and execution platform, the data object including one or more data elements and associated ones of the different functions;
associating in the user interface the data object with an external data object function defined separately from the selected data object as an event processible by an event handler, the association including reference to the one or more data elements and adding a control to the screen for the external data object function; and,
registering the external data object function with an event handler for the application development and execution platform.

2. The method of claim 1, further comprising:
deploying the selected data object as a selectable element in a user interface definition canvas of a solutions development module coupled to the application development and execution platform;
selecting a corresponding user interface control adapted to access the external data object function;
positioning the selected corresponding user interface control in a user interface screen of a solution reflective of a customized form of the application; and,
persisting the user interface screen for use with the solution as the customized form of the application.

3. The method of claim 1, further comprising:
displaying a dialog in the user interface including a prompt to select a customizable parameter characterizing the data object; and,
writing meta data to the data object encapsulating the customizable parameter.

4. The method of claim 3, wherein the customizable parameter is a specific database manager managing create, update and delete operations on the data object.

5. The method of claim 1, wherein the different functions exposed by the API of the application additionally include a supplemental function externally registered with the application development and execution platform in addition to those of the functions which are included as part of the API.

6. A data processing system adapted for data object definition and registration, the system comprising:
a host computing platform comprising one or more computers, each with memory and one or processing units including one or more processing cores;
an application development and execution platform executing by the one or more processing cores of the host computing platform;
an event handler for the application development and execution platform;
an application programming interface (API) of an application defined within the application development and execution platform; and,
a data object definition and registration module comprising computer program instructions enabled while executing in the memory of at least one of the processing units of the host computing platform to perform:
invoking a data object creation user interface in an object manager of an application development and execution platform;
placing a screen in the data object creation user interface;
selecting a data object in the user interface for association with different functions exposed by the API of the application defined within the application development and execution platform, the data object including one or more data elements and associated ones of the different functions;
associating in the user interface the data object with an external data object function defined separately from the selected data object as an event processible by an event handler, the association including reference to the one or more data elements and adding a control to the screen for the external data object function; and,
registering the external data object function with the event handler.

7. The system of claim 6, wherein the computer program instructions are further enabled to perform:
deploying the selected data object as a selectable element in a user interface definition canvas of a solutions development module coupled to the application development and execution platform;
selecting a corresponding user interface control adapted to access the external data object function;
positioning the selected corresponding user interface control in a user interface screen of a solution reflective of a customized form of the application; and,
persisting the user interface screen for use with the solution as the customized form of the application.

8. The system of claim 6, wherein the computer program instructions are further enabled to perform:
displaying a dialog in the user interface including a prompt to select a customizable parameter characterizing the data object; and,
writing meta data to the data object encapsulating the customizable parameter.

9. The system of claim 8, wherein the customizable parameter is a specific database manager managing create, update and delete operations on the data object.

10. The system of claim 8, wherein the different functions exposed by the API of the application additionally include a supplemental function externally registered with the application development and execution platform in addition to those of the functions which are included as part of the API.

11. A computing device comprising a non-transitory computer readable storage medium having program instructions stored therein, the instructions being executable by at least one processing core of a processing unit to cause the processing unit to perform data object definition and registration, by:
invoking a data object creation user interface in an object manager of an application development and execution platform;
placing a screen in the data object creation user interface;
selecting a data object in the user interface for association with different functions exposed by an application programming interface (API) of an application defined within the application development and execution platform, the data object including one or more data elements and associated ones of the different functions;
associating in the user interface the data object with an external data object function defined separately from the selected data object as an event processible by an event handler, the association including reference to the one or more data elements and adding a control to the screen for the external data object function; and,
registering the external data object function with an event handler for the application development and execution platform.

12. The device of claim 11, wherein the program instructions further cause the processing unit to perform data object definition and registration, by additionally:
deploying the selected data object as a selectable element in a user interface definition canvas of a solutions development module coupled to the application development and execution platform;
selecting a corresponding user interface control adapted to access the external data object function;
positioning the selected corresponding user interface control in a user interface screen of a solution reflective of a customized form of the application; and,
persisting the user interface screen for use with the solution as the customized form of the application.

13. The device of claim 11, wherein the program instructions further cause the processing unit to perform data object definition and registration, by additionally:
displaying a dialog in the user interface including a prompt to select a customizable parameter characterizing the data object; and,
writing meta data to the data object encapsulating the customizable parameter.

14. The device of claim 13, wherein the customizable parameter is a specific database manager managing create, update and delete operations on the data object.

15. The device of claim 11, wherein the different functions exposed by the API of the application additionally include a supplemental function externally registered with the application development and execution platform in addition to those of the functions which are included as part of the API.
